(19) United States
(12) Patent Application Publication
(10) Pub. No.: US 2025/0252499 A1
(43) Pub. Date: Aug. 7, 2025

(54) SYSTEMS AND METHODS FOR PORTFOLIO PACING

(71) Applicant: JPMorgan Chase Bank, N.A., New York, NY (US)

(72) Inventors: Sandeep Dantuluri, Monroe Township, NJ (US); Benjamin Lenning, Staten Island, NY (US); Katherine Donovan Morgan, New york, NY (US); Kristin Kallergis Rowland, Riverside, CT (US); Berta Gurgova, Syosset, NY (US); Yuezhizi Li, New York, NY (US); Bhupesh Kumar, Mumbai (IN); Bharanidharan Muthusamy, Monroe Township, NJ (US); Saurabh Gupta, Bengaluru (IN); Robert Seymour, Wappingers Falls, NY (US); Jonathan Morgan, Plainview, NY (US)

(73) Assignee: JPMorgan Chase Bank, N.A., New York, NY (US)

(21) Appl. No.: 18/608,289

(22) Filed: Mar. 18, 2024

(30) Foreign Application Priority Data
Feb. 2, 2024 (IN) 202411007262

(51) Int. Cl. G06Q 40/06

(52) U.S. Cl. CPC G06Q 40/06

(57) ABSTRACT

Aspects of the subject disclosure may include, for example, receiving user inputs, including a portfolio market value, a portfolio growth rate, an SAA percentage, an allocation percentage for asset class(es), a number of future equal periodic capital commitments, and/or a timeframe for achieving the SAA percentage, obtaining projections for the asset class(es) based on an aggregated dataset relating to the asset class(es) and information regarding existing capital commitments in the asset class(es), determining values based on the user inputs and the projections, wherein the values include a proposed amount of each future equal periodic capital commitment, a projected timeframe for reaching the SAA percentage, proposed amounts of varying future capital commitments for individual periods in the timeframe, and/or a rate of change relating to the proposed amounts of varying future capital commitments, and deriving and presenting a portfolio plan using the values. Other embodiments are disclosed.

### CROSS-REFERENCE TO RELATED APPLICATION

The present application claims priority to Indian Patent Application number 202411007262 filed on Feb. 2, 2024. All sections of the aforementioned application are incorporated herein by reference in their entirety.

### FIELD OF THE DISCLOSURE

The subject disclosure relates to systems and methods for portfolio pacing.

### BACKGROUND

Private investments (PI) (or private market holdings) are a class of self-liquidating assets, where their net asset value (NAV) increases as capital is called and deployed to portfolio companies or assets, and decreases as capital is returned to investors in the form of distributions. Investment advisors at financial institutions often assist investors (or end clients) with their PIs.

### BRIEF DESCRIPTION OF THE DRAWINGS

Reference will now be made to the accompanying drawings, which are not necessarily drawn to scale, and wherein:

FIG. 1 illustrates the change in NAV of an example fund over time.

FIG. 2A is a block diagram illustrating an example, non-limiting embodiment of a pacing platform, in accordance with various aspects described herein.

FIG. 2B illustrates a median level residual-value-to-committed capital (RVCC) for a buyout fund, plotted against years since inception/commitment.

FIG. 2C illustrates historical and forecast NAV for existing buyout fund commitments.

FIG. 2D illustrates an example NAV progression for initial commitments in a case where equal commitments are made each year.

FIG. 2E illustrates an example NAV progression in a case where decreasing commitments are made over time.

FIG. 2F illustrates another example NAV progression with initial commitments.

FIGS. 2G to 2P show various interfaces that may be presented, illustrating example inputs and outputs relating to the pacing platform of FIG. 2A.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

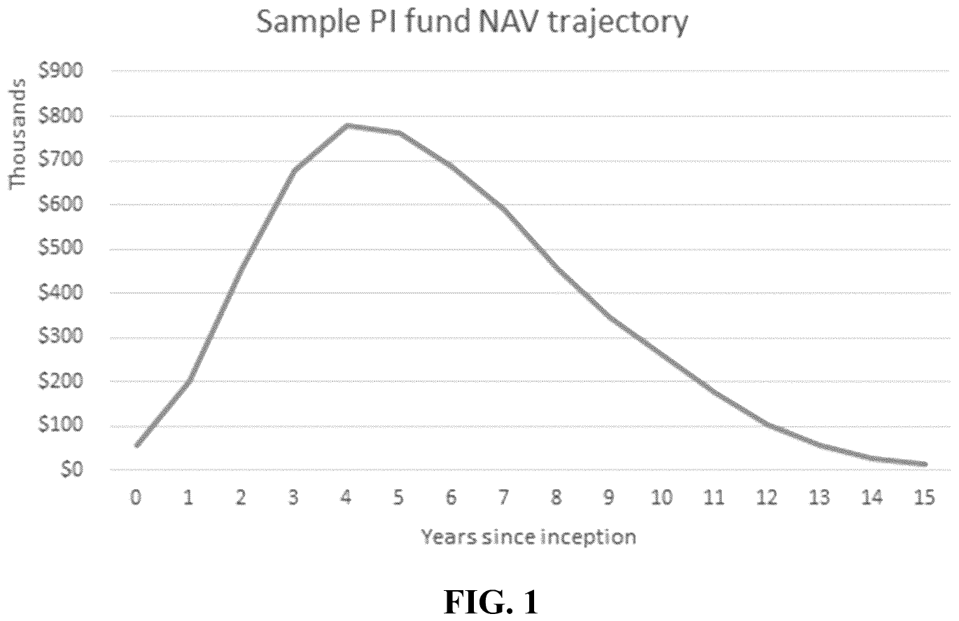

FIG. 1 illustrates the change in NAV of an example fund over time. Investors generally face challenges in two fold. First, there is often a significant wait time before committed capital can be fully invested, and thus there is uncertainty with the time that is needed to achieve a target allocation. Second, to maintain the target allocation, investors may need to continually make new capital commitments. The self-depleting nature of investments in PI funds over their lifecycle means that additional capital commitments are required in the capital distribution period of the mid-later years in order for the investor to stay invested at Strategic Asset Allocation (SAA) levels (i.e., the percentage of an investor's overall portfolio that is allocated or dedicated for PI). Furthermore, investors may have other objectives and constraints, such as asset class and vintage year diversification, portfolio liquidity need, and rebalancing constraints. In any case, it is believed that investment advisors currently lack a scalable quantitative basis for estimating investor commitments throughout PI fund lifecycles, including initial and ongoing commitments.

The subject disclosure describes illustrative embodiments of a pacing platform—e.g., a Private Investment Portfolio Pacing (PIPP) platform or tool—that is capable of facilitating the construction of a portfolio of private investments over a set period for achieving a target SAA level. In exemplary embodiments, the pacing platform is capable of projecting ranges of investor commitments that are needed to achieve a target NAV and to stay invested at a target PI share of total portfolio SAA (with adjustable assumptions). The commitments can be equal and/or decelerating/accelerating over time per the investor's target year for NAV. In various embodiments, the pacing platform may be configured with the ability to ascertain an investor's existing holdings as well as allow investment allocations to be designated by strategy type and by year for achieving a certain outcome. In one or more embodiments, the pacing platform may generate a forecast based on this information (and other information, such as upstream model outputs and/or aggregated data-described in more detail below) over multiple years. In one or more embodiments, the pacing platform may provide a user interface (UI), and more particularly a graphical user interface (GUI), that receives user inputs and provides visual outputs.

Exemplary embodiments of the pacing platform determine and output information regarding suggested yearly commitment amounts, which allows investors to achieve target allocation (e.g., SAA) over time, while building the portfolio across asset class and vintage years. This advantageously addresses the two challenges discussed above. The pacing platform advantageously simplifies point-in-time investment transactions into a programmatic approach, where the constructed portfolio can easily be referenced (e.g., each quarter) to guide PI investment activities.

One skilled in the art would readily recognize the technical benefits of the pacing platform, particularly the improved efficiency that it provides to users for investment decision-making. Without the aid of the pacing platform described herein, analyzing existing holdings and forecasting outcomes would need to be performed by hand or using a computer, which would require the manual entry of data values and construction of mathematical formulas on spreadsheets or the like. This results in undue consumption of computer processing resources and computer power resources, and is especially pronounced if each investment advisor individually performs these manual activities for each client. Packaging the pacing platform in a standardized format for use by any number of users (e.g., investment advisors) drastically improves efficiency in not only investment decision-making, since quantification for strategy allocation and portfolio targets can be provided at scale for (e.g., all) investment advisors, but also conserves computer processing resources and computer power resources that would otherwise need to be unduly expended.

One or more aspects of the subject disclosure include a device, comprising a processing system including a processor, and a memory that stores executable instructions that, when executed by the processing system, facilitate performance of operations. The operations may include receiving a set of user inputs, wherein the set of user inputs includes a target portfolio market value, a target portfolio growth rate, a target strategic asset allocation (SAA) percentage, a desired allocation percentage for one or more asset classes, a desired number of future equal periodic capital commitments, a desired timeframe for achieving the target SAA percentage, or a combination thereof. The operations may also include obtaining a plurality of projections for the one or more asset classes based on an aggregated dataset relating to the one or more asset classes and based on information regarding existing capital commitments made in the one or more asset classes. The operations may also include determining a set of values based on the set of user inputs and the plurality of projections, wherein the set of values includes a proposed amount of each of the future equal periodic capital commitments, a projected timeframe for reaching the target SAA percentage, proposed amounts of varying future capital commitments for individual periods in the desired timeframe, a rate of change relating to the proposed amounts of varying future capital commitments, or a combination thereof. The operations may also include deriving and presenting a portfolio plan using the set of values.

One or more aspects of the subject disclosure include a non-transitory machine-readable medium, comprising executable instructions that, when executed by a processing system including a processor, facilitate performance of operations. The operations may include receiving a set of user inputs, wherein the set of user inputs includes a target portfolio market value, a target portfolio growth rate, a target strategic asset allocation (SAA) percentage, a desired allocation percentage for one or more asset classes, and a desired number of future equal periodic capital commitments. The operations may also include obtaining a plurality of forecasts for the one or more asset classes based on an aggregated dataset relating to the one or more asset classes and based on information regarding existing capital commitments made in the one or more asset classes. The operations may also include deriving a set of values based on the set of user inputs and the plurality of forecasts, wherein the set of values includes a proposed amount of each of the future equal periodic capital commitments and a projected timeframe for reaching the target SAA percentage. The operations may also include deriving and presenting a proposed portfolio plan based on the set of values.

One or more aspects of the subject disclosure include a method. The method may include receiving, by a processing system including a processor, a set of user inputs, wherein the set of user inputs includes a target portfolio market value, a target portfolio growth rate, a target strategic asset allocation (SAA) percentage, a desired allocation percentage for one or more asset classes, and a desired timeframe for achieving the target SAA percentage. The method may further include obtaining, by the processing system, a plurality of projections for the one or more asset classes based on an aggregated dataset relating to the one or more asset classes and based on information regarding existing capital commitments made in the one or more asset classes. The method may further include determining, by the processing system, a set of values based on the set of user inputs and the plurality of projections, wherein the set of values includes proposed amounts of varying future capital commitments for individual periods in the desired timeframe and a rate of change relating to the proposed amounts of varying future capital commitments. The method may further include deriving and presenting, by the processing system, a portfolio plan using the set of values.

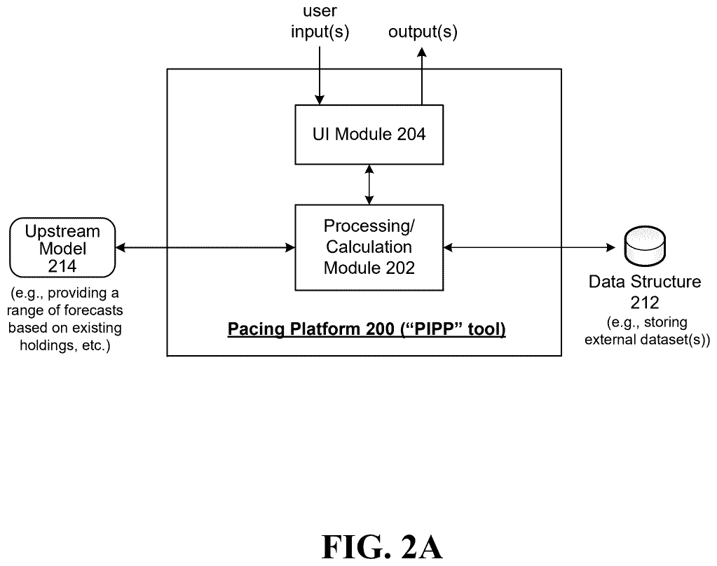

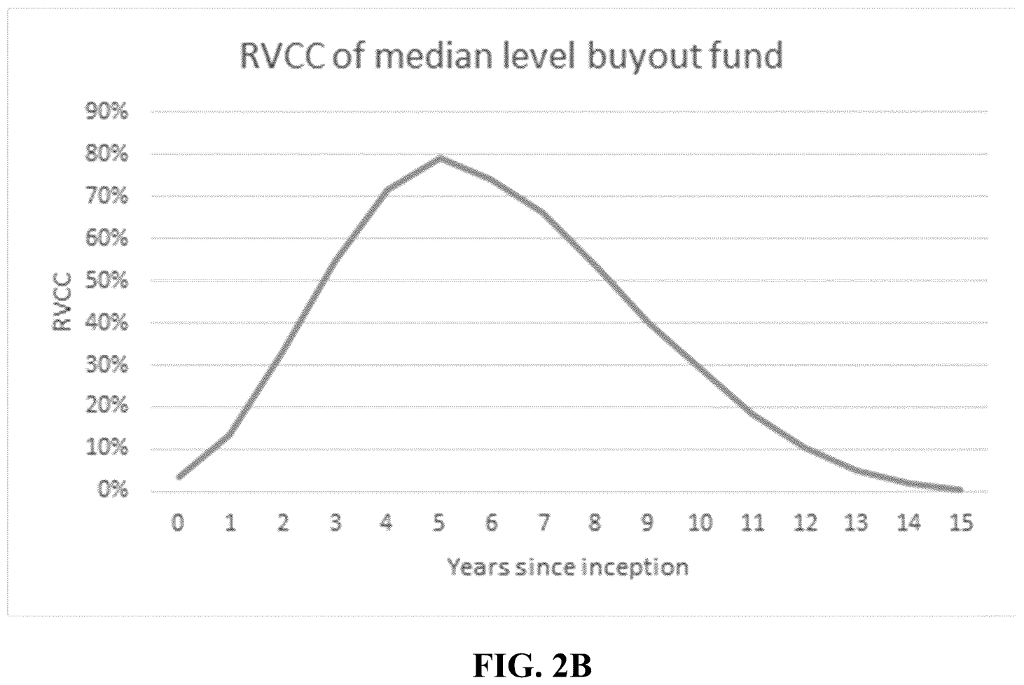

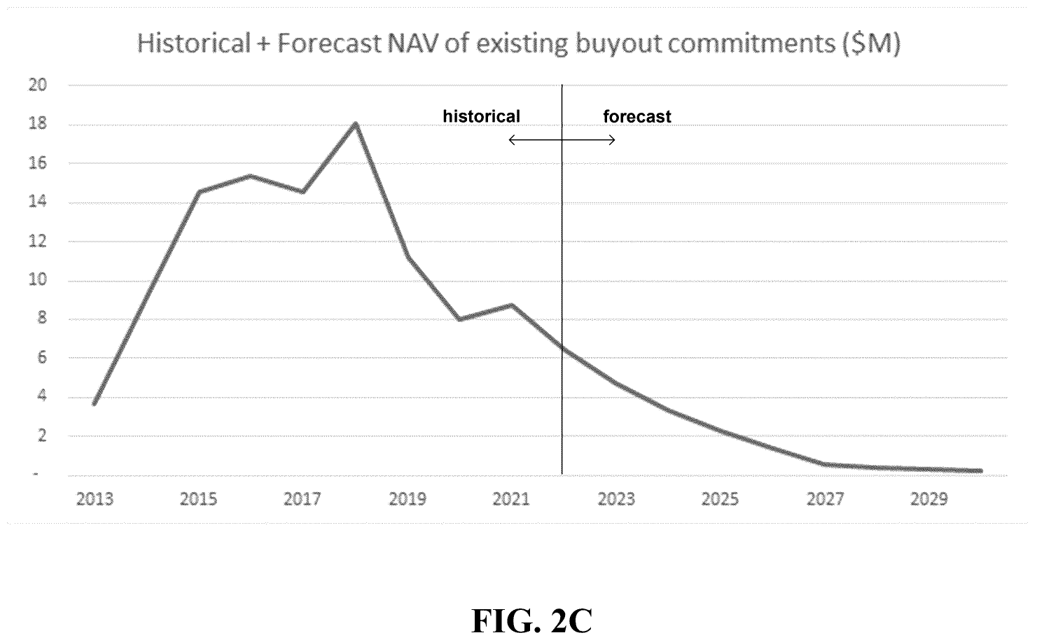

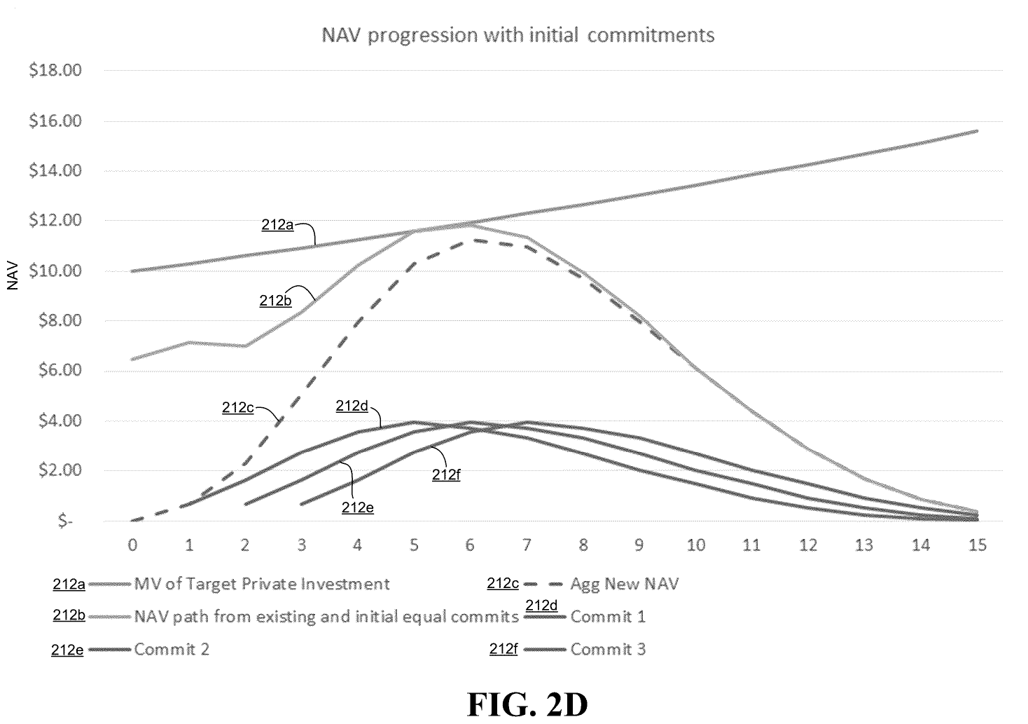

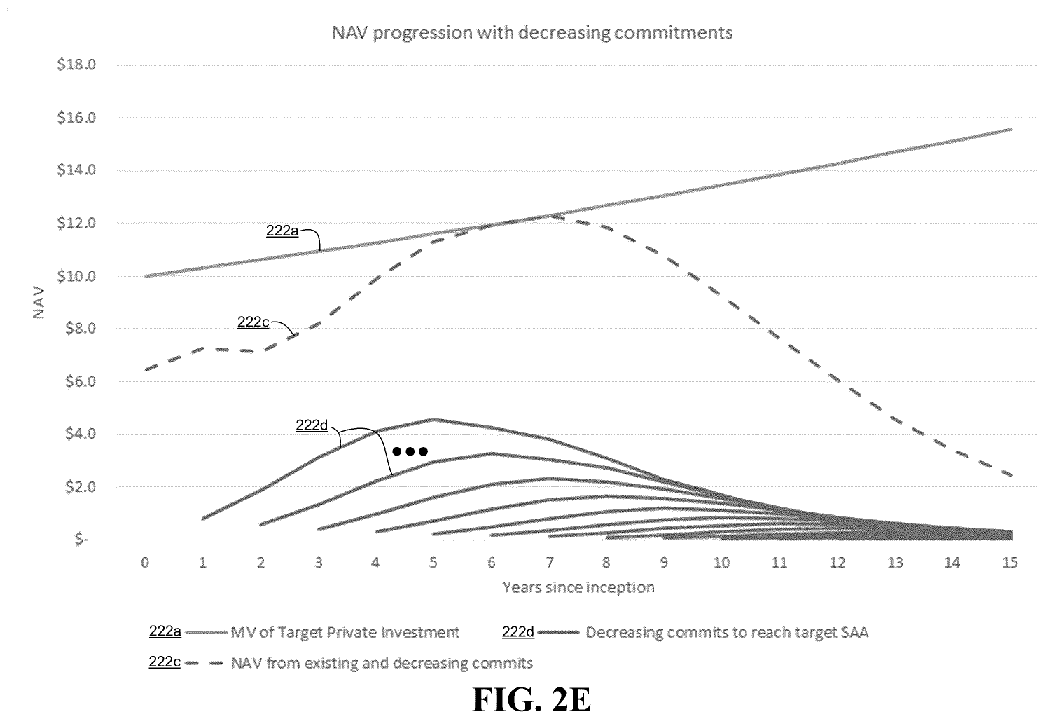

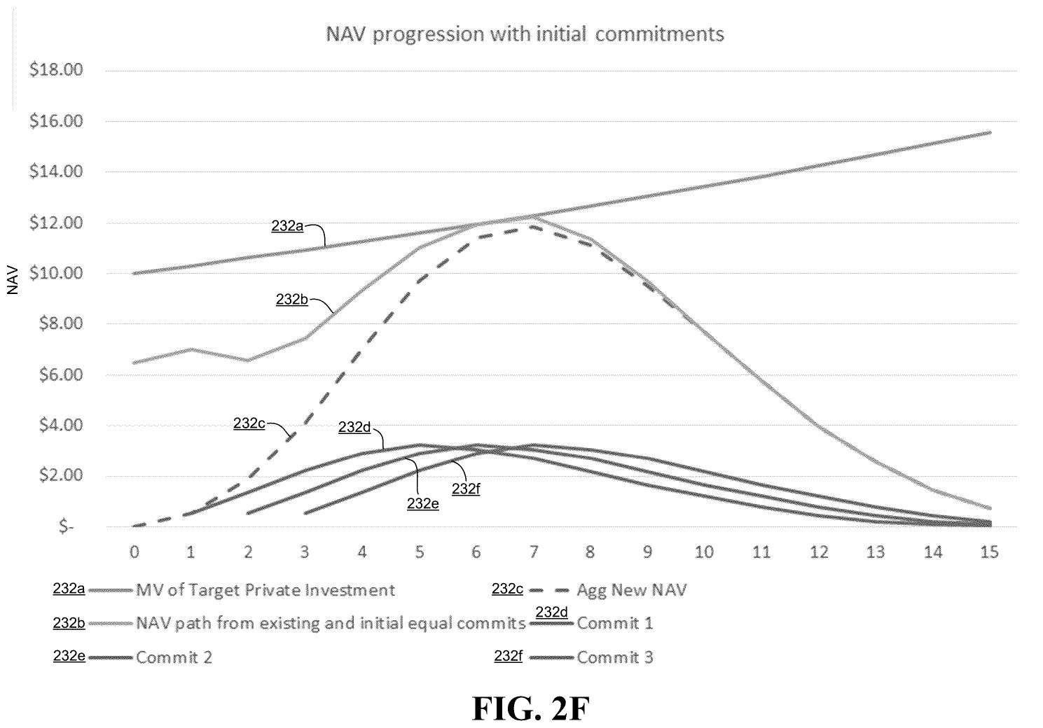

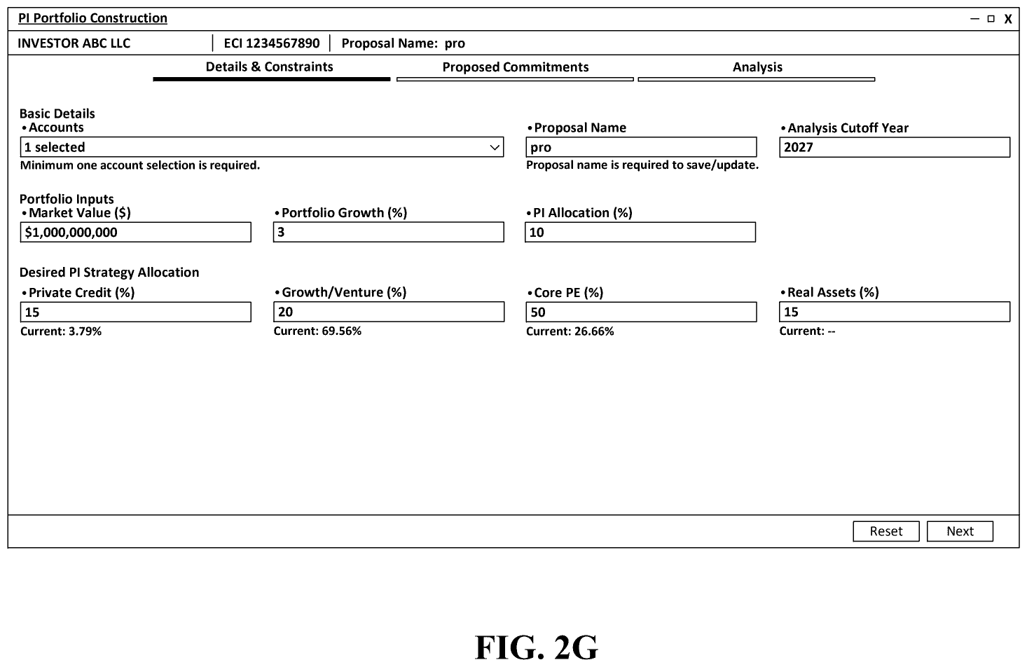

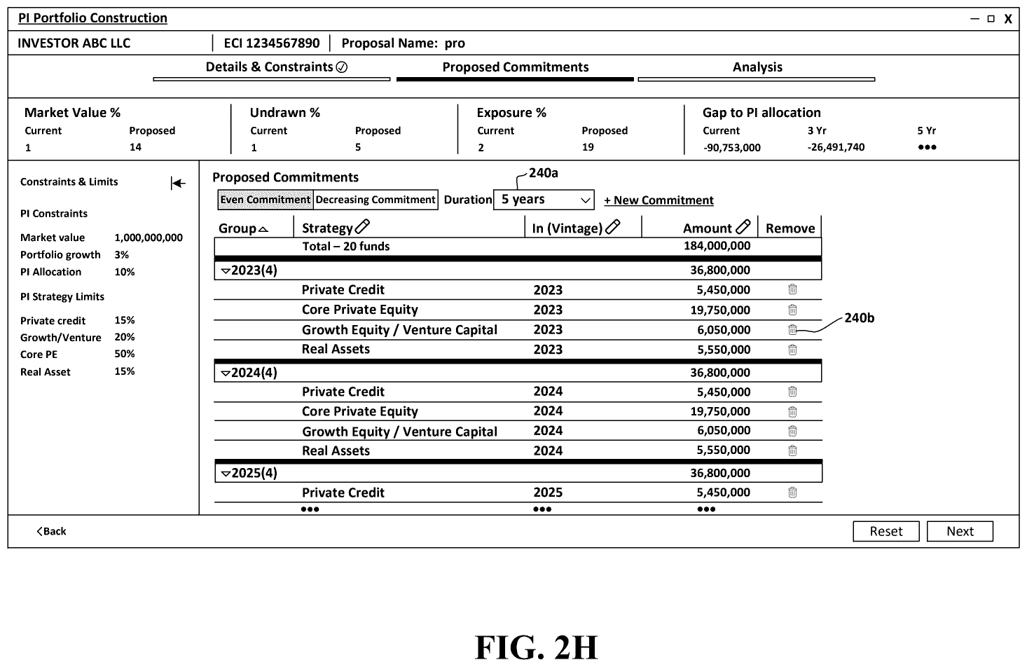

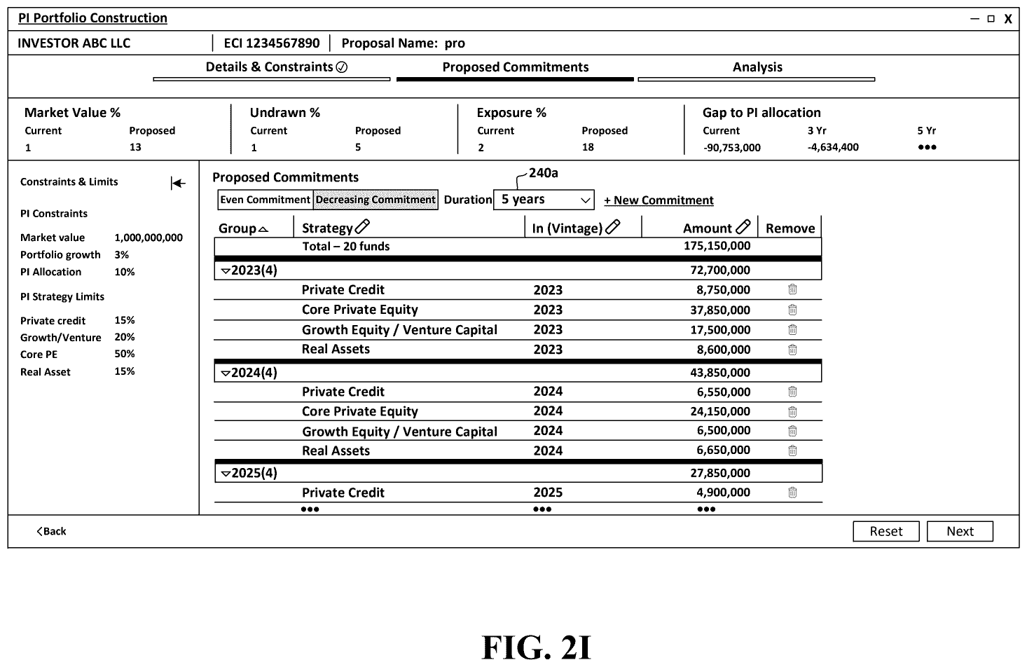

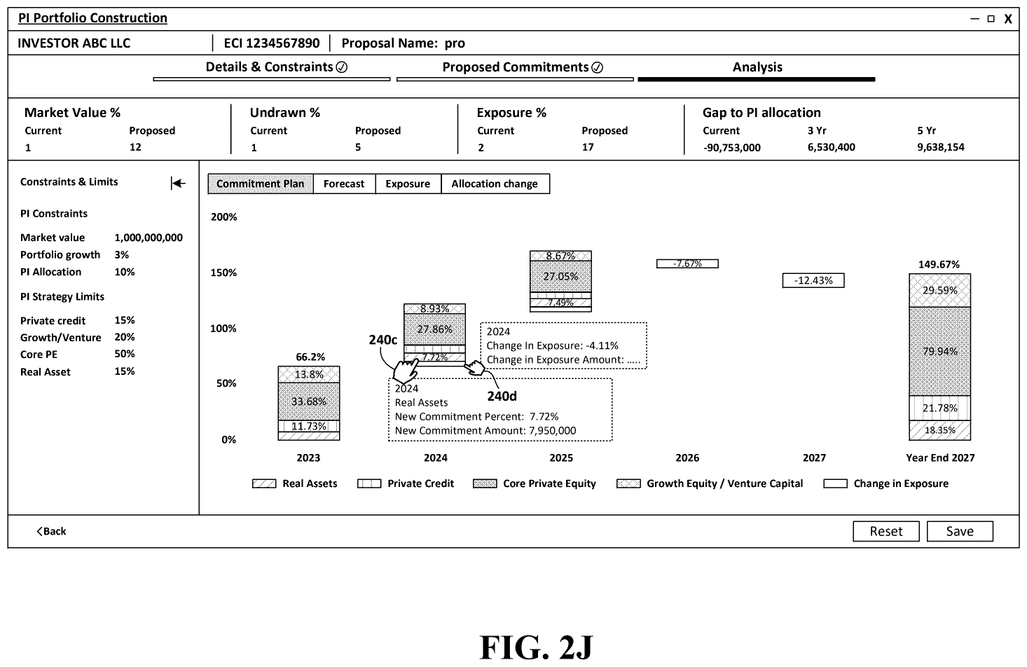

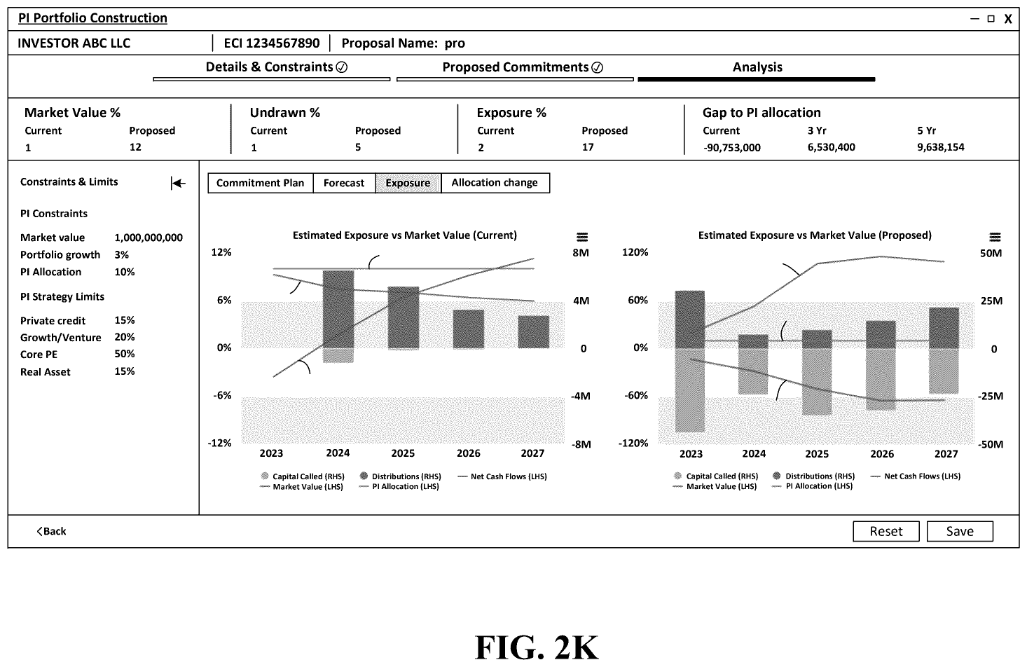

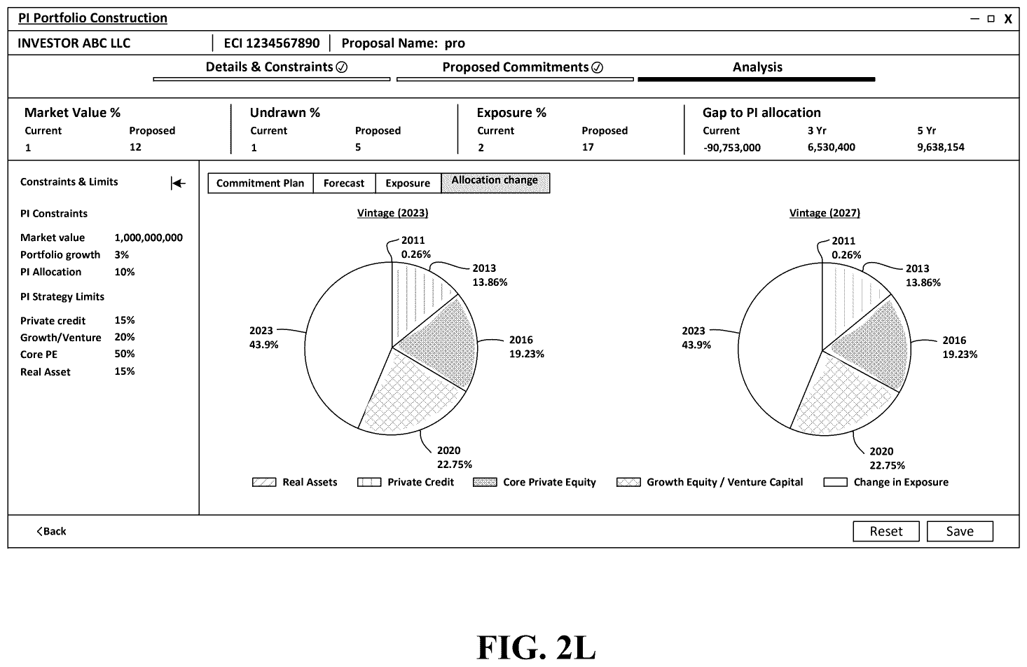

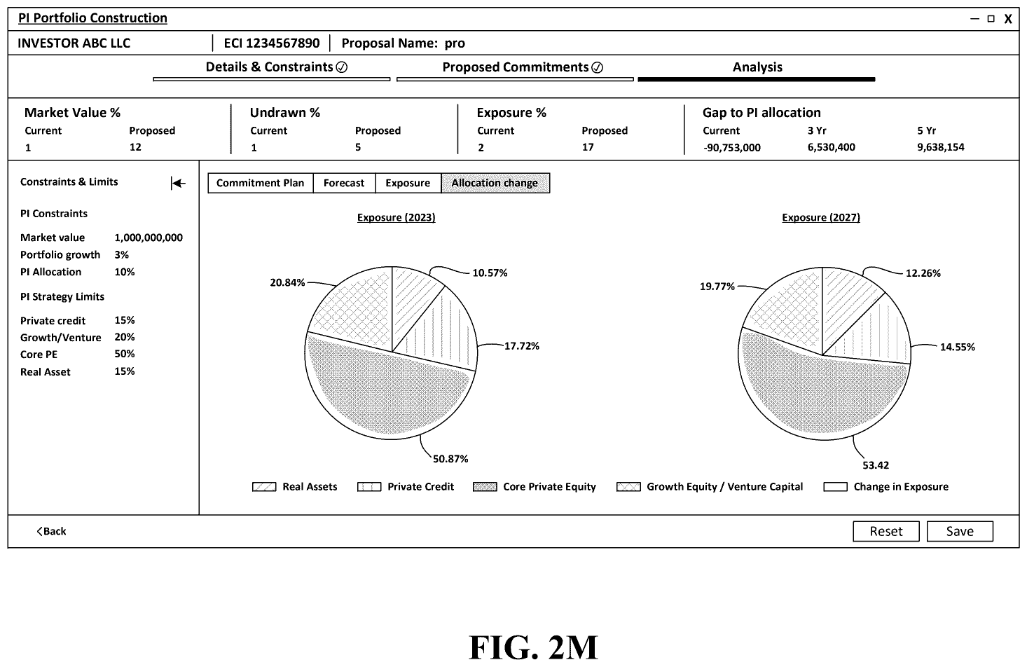

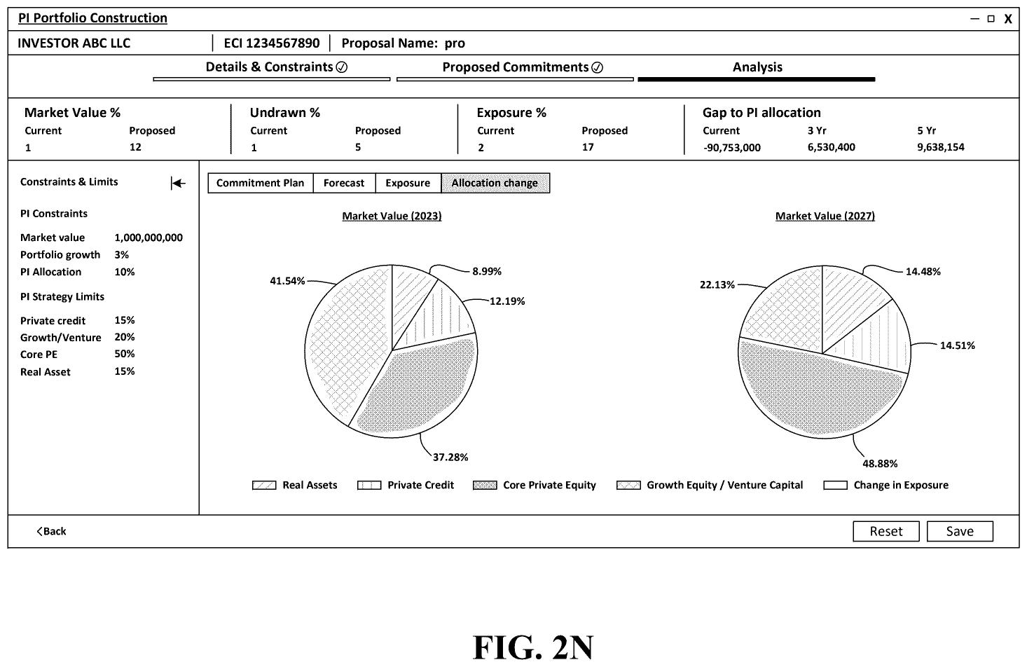

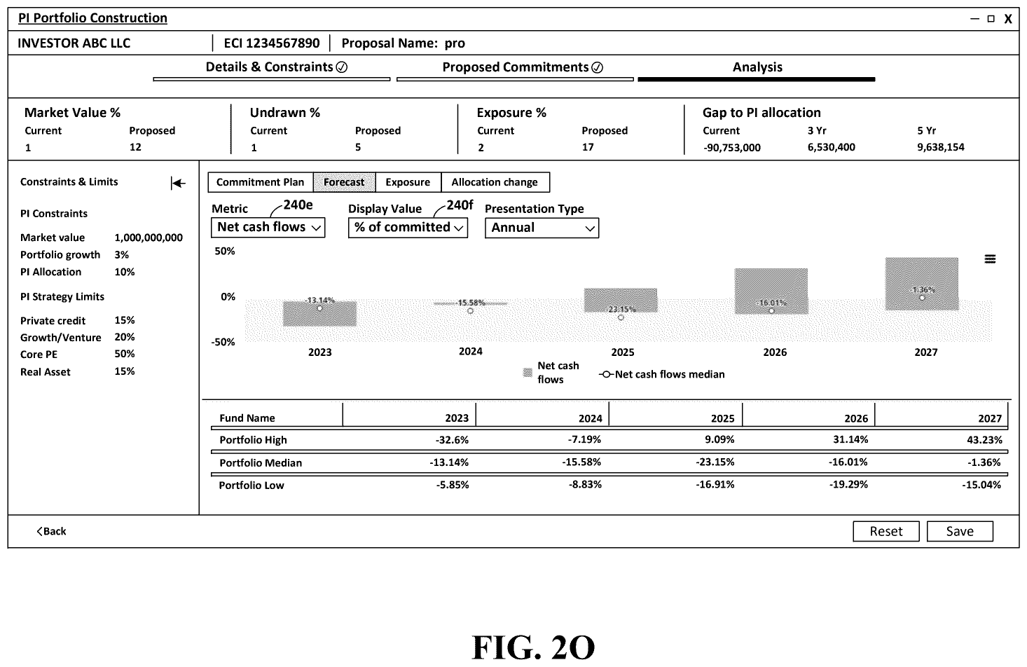

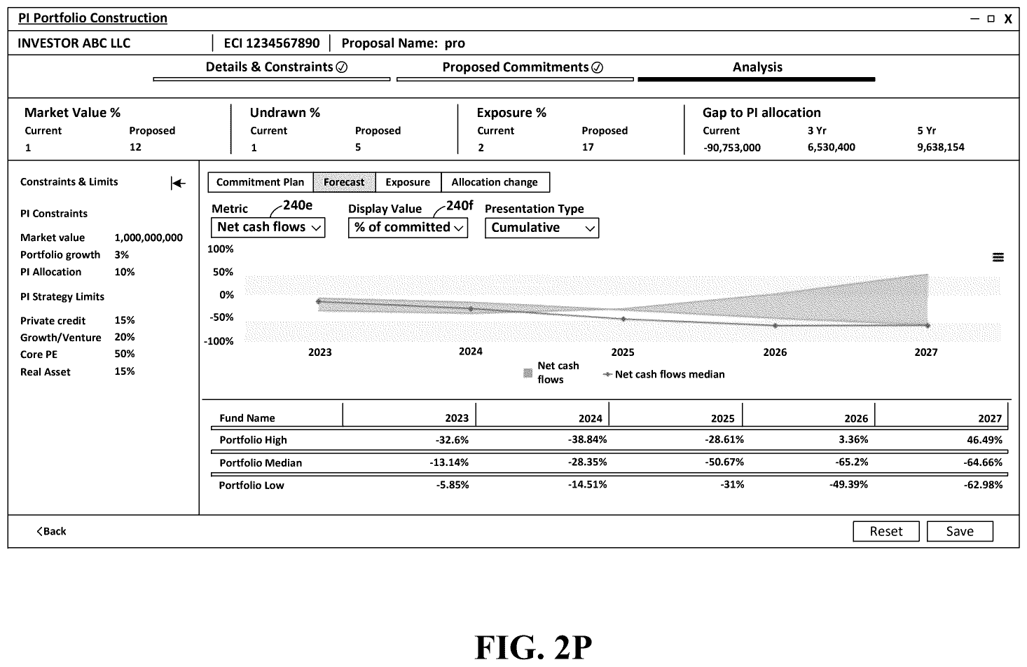

FIG. 2A is a block diagram illustrating an example, non-limiting embodiment of a pacing platform 200, in accordance with various aspects described herein. In one or more embodiments, the pacing platform 200 can facilitate the construction of a portfolio of private investments over a set period for achieving a target allocation level. In exemplary embodiments, the pacing platform 200 may be configured to measure target portfolio allocation in terms of portfolio NAV.

Although not shown, the pacing platform 200 may be implemented or installed (e.g., as one or more computer executable software packages) in one or more computing devices or may alternatively be implemented or installed on a server device that is communicatively coupled or accessible to one or more computing devices over a network. In a case where the pacing platform 200 is communicatively coupled to the one or more computing devices, the network may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

As shown in FIG. 2A, the pacing platform 200 may include a processing/calculation module 202 and a UI module 204. As also depicted, the pacing platform 200 may be communicatively coupled to, or otherwise may have access to, a data structure 212 and an upstream model 214. Although not shown, the pacing platform 200 may be equipped with communication interfaces that enable interactions with and/or information retrieval from the data structure 212, the upstream model 214, and/or other components or systems.

The processing/calculation module 202 may be configured to operate based on aggregated dataset(s), model-driven inputs, and user-provided inputs. The various functionalities of the processing/calculation module 202 are described in more detail further below. The UI module 204 may be configured to respond to user inputs and present (e.g., display) information to users. The UI module 204 may provide a graphical user interface, a non-graphical user interface, a text-based user interface, and/or the like. In various embodiments, the UI module 204 may provide information for display. In some embodiments, a user may interact with the information, such as by providing inputs via an input component of a computing device that executes the pacing platform 200. In certain embodiments, the UI module 204 may be configurable by a computing device and/or by a user (e.g., a user may change the size of an interface provided by the UI module 204, information provided via the interface, positioning of information provided by the interface, etc.). Additionally, or alternatively, the UI module 204 may be set with a standard or default interface configuration, a specific configuration based on a type of device on which the interface is displayed, and/or a set of configurations based on capabilities and/or specifications associated with a device on which the interface is displayed. The UI module 204 may be configured with various functionalities, such as graph-generating and/or table-generating functionalities for generating tabular and/or graphical representations of data.

The data structure 212 may be implemented in a database, a table, a trie, a linked list, an array, and/or the like, and may be configured to store various data, such as aggregated vendor dataset(s). In certain embodiments, the data structure 212 may alternatively be incorporated in the pacing platform 200. In one or more embodiments, the pacing platform 200 may obtain, from the data structure 212, aggregated vendor data and operate on that data as part of its processing/calculation functionality. Aggregated vendor data may include, for instance, industry-wide PI data that encompasses fund-level historical capital calls and distributions, at the strategy/asset class level (e.g., private credit, growth equity/venture capital, core private equity (PE), real assets, etc.) and by vintage year (i.e., the year that the fund was issued or created). An example of aggregated vendor data is Cambridge Associates data, which provides default RVCC projections.

| | | |
|---|---|---|
| rvccᵢₜ | Projected NAV-to- | input, e.g., aggregated from |
| | committed capital | Cambridge Associates dataset |
| | conversion ratio of | or the like |
| | strategy i, at year t | |

In a case where an investor is currently invested in, or is interested in investing in, a venture capital fund, information in the aggregated vendor data regarding venture capital funds may be leveraged as a benchmark for projecting future outcomes.

The pacing platform 200 may interact with the upstream model 214 to obtain projection information. In various embodiments, the pacing platform 200 may provide, to the upstream model 214, data regarding an investor's pre-existing commitments in particular asset classes, which the upstream model 214 may generate and provide PI cash flow forecasts (or projections) for. In some embodiments, the pacing platform 200 may additionally provide, to the upstream model, portion(s) of the aggregated dataset and/or information derived based on portion(s) of the aggregated dataset to facilitate generation of the PI cash flow forecasts. In one or more embodiments, the pacing platform 200 may determine required new commitments based on these projections.

| | | |
|---|---|---|
| navᵢₜ | Projected NAV of | input from upstream model |
| | existing commitment in | |
| | strategy i, at year t | |

In one or more embodiments, the upstream model may be statistically or quantitatively driven, where parameters may be adjusted and fitted to a normal distribution. Of course, as asset classes may not necessarily be normally distributed, backwards and forwards fitting may be performed so as to apply normal distribution outcomes. In various embodiments, the upstream model may perform simulations (e.g., using one or more methods, such as a Monte Carlo simulation method or the like) to project a range of outcomes or possibilities relating to paid-in capital (i.e., the amount of capital that an investor has contributed or “paid in” to an investment fund), distributions, and/or NAV. Producing a range of outcomes, rather than a discrete outcome, facilitates compliance with regulations, such as those imposed by the Financial Industry Regulatory Authority (FINRA) or the like. In one or more embodiments, the pacing platform 200 may identify an investor's current holdings and vintage of the held funds, mapped to strategy, and may leverage the upstream model to affinitize those funds to the closest benchmark at the strategy level. In this way, the pacing platform 200 may consider the strategies of an investor's existing funds, and leverage the aggregated data set to determine the behavior of those funds relative to capital events (i.e., expectations in terms of calls of capital, distribution of proceeds, etc.).

The pacing platform 200 may allow users (e.g., investment advisors or clients) to input a variety of assumptions—e.g., except for aggregated/projection data, such as the aforementioned RVCC projection and/or NAV projection for existing commitments. In one or more embodiments, the pacing platform 200 may accommodate or work with two sets of user-defined input assumptions, namely predefined number of commitments and predefined number of years to target allocation. Below are example user-provided inputs that the pacing platform 200 may receive (e.g., via the UI module 204) and operate on. In a case where equal commitments are to be made each period (e.g., each year), the user-provided inputs may include the following.

### Equal Commitments

| | | |
|---|---|---|
| MVₜ | Target Total Portfolio | Target total portfolio at year t, |
| | Market Value ($) | including allocation to other |
| | | asset classes |
| G | Total Portfolio Year- | The tool may assume constant |
| | over-Year Growth Rate | growth rate over the 15 year |
| | (%) | projected periods |
| P | Private Investment | The tool may assume target PI |
| | Strategic Asset | allocation constant over, e.g., |
| | Allocation (% as of total | 15 years of projected periods |
| | portfolio) | |
| wᵢ | Asset Class Allocation | The tool may assume constant |
| | (% in strategy i) | asset class/strategy allocation; |
| | | summing up to 100% |
| N | Number of | Number of yearly equal |
| | commitments | commitment |

In a different case where decreasing commitments are to be made over time (e.g., where investment capital is frontloaded such that less and less is committed over the next few years), the user-provided inputs may include the following.

### Decreasing Commitments.

| | | |
|---|---|---|
| MVₜ | Target Total Portfolio | Target total portfolio at year t, |
| | Market Value ($) | including allocation to other |
| | | asset classes |
| G | Total Portfolio Year- | The tool may assume constant |
| | over-Year Growth Rate | growth rate over the 15 year |
| | (%) | projected periods |
| P | Private Investment | The tool may assume target PI |
| | Strategic Asset | allocation constant over, e.g., |
| | Allocation (% as of total | 15 years of projected periods |
| | portfolio) | |
| wᵢ | Asset Class Allocation | The tool may assume constant |
| | (% in strategy i) | asset class/strategy allocation; |
| | | summing up to 100% |
| K | Required Year to Target | Required number of years to |
| | Allocation | achieve target allocation |

In some embodiments, the pacing platform 200 may operate based on certain assumptions or limitations. For instance, the pacing platform 200 may or may not have any explicit assumption(s) of public/private market correlations. As another example, the pacing platform 200 may or may not assume that new commitments perform at median levels of (e.g., Cambridge Associate) funds of the same strategy. As yet another example, the pacing platform 200 may or may not assume that the portfolio growth rate and/or the SAA remains constant over time. As a further example, the pacing platform 200 may or may not account for reinvestment of distributions.

In exemplary embodiments, the pacing platform 200, and more particularly the processing/calculation module 202, may be configured to determine and provide various outputs. For instance, in the case of equal commitments, the processing/calculation module 202 may determine and provide the following outputs.

### Equal Commitments

| | | |
|---|---|---|
| C_{y} | Required commitment | N equal commitments to |
| | ($) made in year y | achieve target allocation |
| C′_{y} | Additional commitment | Post reaching target allocation, |
| | ($) made in year y to | new commitments required to |
| | maintain target SAA | offset decreasing NAV (y > M). |
| M | Realized year to target | With N equal commitments, by |
| | SAA | the Mth year, aggregated NAV |
| | | reaches target |

In the case of decreasing commitments, the processing/calculation module 202 may determine and provide the following outputs.

### Decreasing Commitments

| | | |
|---|---|---|
| C_{y} | Required commitment | Required decreasing |
| | made in year y ($) | commitments to achieve target |
| | | allocation |
| r | Year over year change | A constant year-over-year rate |
| | of commitment | of change C_{y} = C₀ * r^{y-1} |
| C′_{y} | Additional commitment | Post reaching target allocation, |
| | ($) made in year y to | new commitments required to |
| | maintain target SAA | offset decreasing NAV (y > K). |

For simplicity of description, example calculations that the processing/calculation module 202 may implement will now be described in the context of an example buyout/core (core PE) strategy. It is to be understood and appreciated that the same/similar calculations may apply to other types of strategies (e.g., private credit, growth equity/venture capital, real assets, etc.) so as to arrive at required yearly commitments for all of the relevant strategies that are employed in a portfolio.

To achieve a target strategy allocation under the umbrella of a broad PI SAA level at, say, 10% of the investor's total portfolio, the processing/calculation module 202 may run the pacing process in the same manner for each strategy—e.g., so as to target 2% in private credit, 2% in real assets, 4% in core PE, and 2% in growth/venture (as shown in the example table below), but may do so with simultaneous consideration of all of these strategies. The yearly commitment for the final portfolio may be the sum of yearly commitments at the strategy level.

| | |
|---|---|
| Portfolio Market Value ($m) | 100 |
| Portfolio YoY growth (%) | 3 |
| Private Credit Allocation (%) | 2 |

| | |
|---|---|
| Portfolio Market Value ($m) | 100 |
| Portfolio YoY growth (%) | 3 |
| Real Assets Allocation (%) | 2 |

| | |
|---|---|
| Portfolio Market Value ($m) | 100 |
| Portfolio YoY growth (%) | 3 |
| Core PE Allocation (%) | 4 |

| | |
|---|---|
| Portfolio Market Value ($m) | 100 |
| Portfolio YoY growth (%) | 3 |
| Growth/Venture Allocation (%) | 2 |

The processing/calculation module 202 may be configured to assume that new committed capital made each year for a single strategy follows the median level RVCC trajectory. In this case, the processing/calculation module 202 may derive (or cause to be derived, such as by controlling an analysis/processing system) a median level RVCC trajectory based on multi-year industry reference data, such as Cambridge Associates data or the like. This may involve obtaining and “building” this data up to NAV in each of successive years. FIG. 2B illustrates a median level RVCC for a buyout fund, plotted against years since inception/commitment. As can be seen, for each $1 commitment made in year 0, the median level RVCC gradually grows to around 80 cents of residual value/NAV at peak level by year 5, and then decreases back to around 0 cents by year 15.

The processing/calculation module 202 may be configured to factor in existing commitments in respective strategies, and more particularly the forecast NAV for existing commitments (e.g., from the above-described upstream model). Of course, for accounts that have no prior commitments, values may be set to zero. The processing/calculation module 202 may identify an investor's existing holdings (with respect to cashflow forecasting) mapped to strategy type. User inputs regarding these holdings as well as regarding interested strategy types and/or goals at the strategy level may be provided or forwarded to the upstream model to facilitate generation of the NAV forecast. FIG. 2C illustrates historical and forecast NAV for existing buyout fund commitments. In various embodiments, the processing/calculation module 202 may obtain the forecast NAV, determine a target NAV (projection), and determine the delta between the historical NAV and the target NAV to identify the additional commitments that the investor will need to add or make for the respective strategies. The processing/calculation module 202 may facilitate determination of NAV progression for reaching the target SAA, in two different scenarios: (a) where equal commitments are made each period (e.g., year) and (b) where decreasing commitments are made in successive periods (e.g., from year to year).

FIG. 2D illustrates an example NAV progression for initial commitments in a case where equal commitments are made each year. Line 212a represents the target buyout market value over time, growing at the total portfolio growth rate G, where

$${MV}_{t} = {MV}_{0} * P * {w}_{buyout} * {( 1 + G )}^{t} .$$

Line 212b represents the NAV path from existing and initial equal commitments, line 212c represents the aggregate new NAV, and lines 212d, 212e, and 212f represent successive commitments in years 1, 2, and 3, respectively. For the aggregate NAV, from both existing and newly-added commitments, to reach MVₜ, the pacing platform 200 may solve for two conditions.

### First Condition:

$${NAV}_{t} = {nav}_{buyout , t} + {\sum }_{0}^{N} {C}_{n} \times {rvcc}_{buyout , ( t - y + 1 )}$$

$${NAV}_{t} = {MV}_{t} ,$$

where N is the number of equal commitments, nav_{buyout,t} is the forecast NAV of existing buyout commitments by year _{t,} and Σ₀^{Y} C_{y}×RVCC_{buyout, (t-y+1)} is the sum of forecast NAV of each newly-added, equal commitment. For instance, for the commitment made in year 2, C₂, the forecast NAV by year 5 (t), equals commitment amount C₂ multiplied by TVCC_{buyout,4}, the residual-to-committed capital ratio as of the 4^{th} year since inception. Intuitively, the new buyout commitment made in year 2 will have been put into use for 4 years as of year 5.

### Second Condition:

$$\frac{dMV ( t )}{dt} = \frac{dNAV ( t )}{dt}$$

Here, the second condition requires that, at the realized year to target M (the 5th year as shown in FIG. 2D), MV₅ and NAV₅ should be the tangent point. Given that both curves are not in fact continuous, the condition may be simplified as below to compare the slopes of the curves before and after realized year to target:

$$\frac{NAV ( t + 1 ) - NAV ( t )}{( t + 1 ) - t} < \frac{MV ( t + 1 ) - MV ( t )}{( t + 1 ) - t}$$

$$\frac{NAV ( t ) - NAV ( t - 1 )}{t - ( t - 1 )} > \frac{MV ( t ) - MV ( t - 1 )}{t - ( t - 1 )}$$

In exemplary embodiments, the processing/calculation module 202 may solve for the two conditions above in order to compute the year to target M and the N equal commitment C.

FIG. 2E illustrates an example NAV progression in a case where decreasing commitments are made over time. Similar to the equal commitment approach, here, line 222a illustrates the target buyout market value over time, increasing at the total portfolio growth rate G. Line 222c represents NAV from existing and decreasing commitments, and lines 222d represent successive decreasing commitments over the years. The same (or similar) conditions may be applied to the decreasing commitment approach.

$${NAV}_{K} = {nav}_{buyout , K} + {\sum }_{0}^{K} {C}_{1} {r}^{k - 1} \times {rvcc}_{buyout , ( K - k + 1 )}$$

$${NAV}_{K} = {MV}_{K} ,$$

where nav_{buyout,t} is the forecast NAV of existing buyout commitments by year: _{t,} r represents year over year change of required commitment, and K represents the user-defined required year to target. In contrast to the equal commitment approach, the frontloaded approach here assumes that yearly commitment changes at a rate of r. For year k, the commitment equals C₁rₖ₋₁. Similar to the equal commitment approach, aggregate NAV from both existing and new commitments should equal the target market value. Also, the user-defined year to target K should be the tangent point.

$$\frac{NAV ( K + 1 ) - NAV ( K )}{( K + 1 ) - K} < \frac{MV ( K + 1 ) - MV ( K )}{( K + 1 ) - K}$$

$$\frac{NAV ( K ) - NAV ( K - 1 )}{K - ( K - 1 )} > \frac{MV ( K ) - MV ( K - 1 )}{K - ( K - 1 )}$$

The required year to target K is an input in this approach. The processing/calculation module 202 may solve for C₁ and r such that the two conditions above are met. In this way, for instance, if the investor has a higher risk tolerance and desires to put more capital commitments up front so as to achieve the target NAV sooner, the pacing platform 200 can determine the required commitment for year 1 and the year-over-year decrease in commitment that would suffice.

Given the self-liquidating nature of PI funds, investors need to make new commitments continually in order to maintain the desired level of exposure. The processing/calculation module 202 advantageously determines the required yearly commitment post year-to-target for both approaches (equal commitments and decreasing commitments) as follows. FIG. 2F illustrates another example NAV progression with initial commitments. Line 232a represents the target level exposure, line 232b represents the NAV path from existing and initial equal commitments, line 232c represents the aggregate new NAV, and lines 232d, 232e, and 232f represent successive commitments in years 1, 2, and 3, respectively. As can be seen, to maintain private investment exposure (line 232a), investors should add additional commitments such that, post year-to-target (i.e., year 7), NAV converted from these additional commitments will be able to make up for the gap between target level exposure (232a) and the decreasing total NAV (232c) from a combination of initial and pre-existing commitments before year 0.

Target MV of PI remains unchanged:

$${MV}_{t} = {MV}_{0} * P * {w}_{buyout} * {( 1 + G )}^{t}$$

For any year t after M (realized year to target),

$${NAV}_{t} = {nav}_{buyout , t} + {\sum }_{0}^{N} {C}_{n} \times {rvcc}_{buyout , ( t - n + 1 )} + {\sum }_{M + 1}^{t} {{C}^{′}}_{m} \times {rvcc}_{buyout , ( t - m + 1 )} ,$$

where C′ is the required yearly commitment post year-to-target, made in the ₘth year. Because PI is a self-depleting asset class, over time, the target PI SSA (e.g., 10%) naturally drops if no action is taken to offset the depletion. Thus, the processing/calculation module 202 quantifies the additional amount of commitment that the investor needs to make in order to maintain the target PI SSA. It will be understood and appreciated that proposed future commitments may be deployed into new funds rather than existing funds. It will also be understood and appreciated that new commitments for a strategy type may be divided for deployment to different funds of that strategy type.

FIGS. 2G to 2P show various interfaces that may be presented, illustrating example inputs and outputs relating to the pacing platform 200 of FIG. 2A. As shown in FIG. 2G, the interface may present fields for receiving user inputs, such as, analysis cutoff year, market value of portfolio, desired portfolio growth %, PI allocation %, and PI strategy allocations for private credit, growth/venture, core PE, and real assets. The pacing platform 200 may present a detailed view of proposed future commitment amounts by year for the scenario where equal/even commitments are made over time (FIG. 2H) and where decreasing commitments are made over time (FIG. 2I). Although not shown, the proposed even/decreasing commitment amounts may be adjusted based on the selected “Duration” (reference number 240a in FIGS. 2H and 2I). In one or more embodiments, one or more PI strategies can be removed (e.g., by selecting the corresponding trash bin icon 240b as shown in FIG. 2H), which can trigger the processing/calculation module 202 to rebalance the amounts for the remaining PI strategies. The pacing platform 200 may present a detailed view of a proposed commitment plan for the various PI strategies over the duration, as shown in FIG. 2J. Selections/hovering over certain displayed items may provide additional information (see, e.g., reference numbers 240c and 240d in FIG. 2J, where the vertical axis represents exposure percentage, and where exposure is the sum of NAV and undrawn assets). FIGS. 2K to 2N show various information regarding exposure vs. market value and allocation changes over time. In the legend at the bottom of FIG. 2K, LHS stands for left hand side and RHS stands for right hand side, where both are on different scales/metrics (i.e., % vs. $). FIGS. 2O and 2P respectively show forecasting of portfolio values in annual and cumulative presentation views. Although not shown in FIGS. 20 and 2P, the interface may be adjusted (e.g., via selection of drop down menu 240c) to display information based on a metric other than net cash flows, such as, for instance, capital called, distributions, market value, or total exposure. Although also not shown in FIGS. 20 and 2P, the interface may be adjusted (e.g., via selection of drop down menu 240f) to display information based on a display value other than % of committed capital, such as, for instance, dollar value.

In one or more embodiments, the interface may present options for exporting displayed information, such as graphs, tables, etc. in any desired format (e.g., portable document format (PDF), Joint Photographic Experts Group (JPEG), or the like). It will be appreciated and understood that, while the various interfaces/displays shown in FIGS. 2G to 2P are shown as being arranged in a particular layout, the various interfaces/displays may be arranged in any suitable or desired layout or manner.

In one or more embodiments, the pacing platform 200 may be configured to define or schedule alerts that are to be automatically provided to a user (e.g., an investment advisor or end client) to notify the user of upcoming capital commitments that need to be made in accordance with the constructed portfolio solution generated by the pacing platform 200. Alerts may be provided in any suitable manner, such as via a text message, an e-mail, a pop-up notification on a computer-based system, or the like. In some embodiments, the alert may be provided according to a schedule with buffer time prior to the time when the next commitment is to be called and deployed in one or more funds (e.g., 15 days, 20 days, etc. before the year 2 commitment is to be made, before the year 3 commitment is to be made, and so on). In various embodiments, an alert may provide a link (e.g., a uniform resource locator (URL), a quick-response (QR) code, or the like) that, when accessed, causes a display screen or visual interface to be presented, with prepopulated fields that facilitate the transfer of capital from an end client's account into to one or more managed investment accounts. In one or more embodiments, the pacing platform 200 may additionally, or alternatively, be configured to define or schedule automatic transfers of determined commitment amounts from the end client's account into the one or more managed investment accounts. In this way, the pacing platform 200 advantageously provides for at least the practical applications of automating capital transfers and/or automatically alerting users to the requisite timing of commitments that need to be made based on a constructed portfolio solution.

It is to be understood and appreciated that, although one or more of FIGS. 2A to 2P might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various platforms, modules, structures, models, systems, etc. may have been illustrated in FIG. 2A as separate platforms, modules, structures, models, systems, etc., it will be appreciated that multiple platforms, modules, structures, models, systems, etc. can be implemented as a single platform, module, structure, model, system, etc., or a single platform, module, structure, model, system, etc. can be implemented as multiple platforms, modules, structures, models, systems, etc. Additionally, functions described as being performed by one platform, module, structure, model, system, etc. may be performed by multiple platforms, modules, structures, models, systems, etc., or functions described as being performed by multiple platforms, modules, structures, models, systems, etc. may be performed by a single platform, module, structure, model, system, etc.

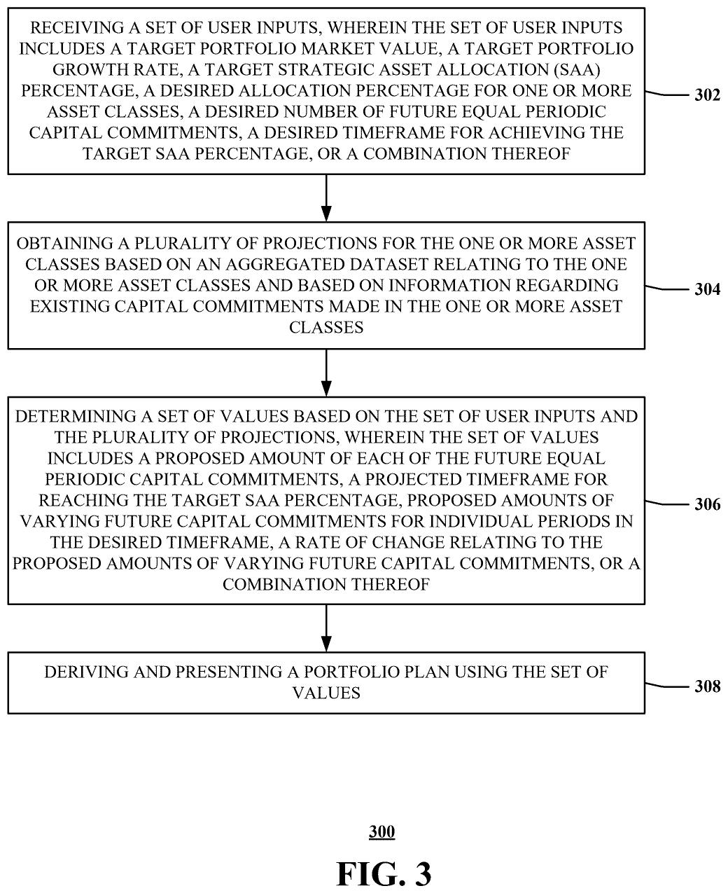

FIG. 3 depicts an illustrative embodiment of a method 300 in accordance with various aspects described herein.

At 302, the method can include receiving a set of user inputs, wherein the set of user inputs includes a target portfolio market value, a target portfolio growth rate, a target strategic asset allocation (SAA) percentage, a desired allocation percentage for one or more asset classes, a desired number of future equal periodic capital commitments, a desired timeframe for achieving the target SAA percentage, or a combination thereof. For example, the pacing platform 200 may, similar to that described above with respect to one or more of FIGS. 2A to 2P, perform one or more operations that include receiving a set of user inputs, wherein the set of user inputs includes a target portfolio market value, a target portfolio growth rate, a target strategic asset allocation (SAA) percentage, a desired allocation percentage for one or more asset classes, a desired number of future equal periodic capital commitments, a desired timeframe for achieving the target SAA percentage, or a combination thereof.

At 304, the method can include obtaining a plurality of projections for the one or more asset classes based on an aggregated dataset relating to the one or more asset classes and based on information regarding existing capital commitments made in the one or more asset classes. For example, the pacing platform 200 may, similar to that described above with respect to one or more of FIGS. 2A to 2P, perform one or more operations that include obtaining a plurality of projections for the one or more asset classes based on an aggregated dataset relating to the one or more asset classes and based on information regarding existing capital commitments made in the one or more asset classes.

At 306, the method can include determining a set of values based on the set of user inputs and the plurality of projections, wherein the set of values includes a proposed amount of each of the future equal periodic capital commitments, a projected timeframe for reaching the target SAA percentage, proposed amounts of varying future capital commitments for individual periods in the desired timeframe, a rate of change relating to the proposed amounts of varying future capital commitments, or a combination thereof. For example, the pacing platform 200 may, similar to that described above with respect to one or more of FIGS. 2A to 2P, perform one or more operations that include determining a set of values based on the set of user inputs and the plurality of projections, wherein the set of values includes a proposed amount of each of the future equal periodic capital commitments, a projected timeframe for reaching the target SAA percentage, proposed amounts of varying future capital commitments for individual periods in the desired timeframe, a rate of change relating to the proposed amounts of varying future capital commitments, or a combination thereof.

At 308, the method can include deriving and presenting a portfolio plan using the set of values. For example, the pacing platform 200 may, similar to that described above with respect to one or more of FIGS. 2A to 2P, perform one or more operations that include deriving and presenting a portfolio plan using the set of values.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

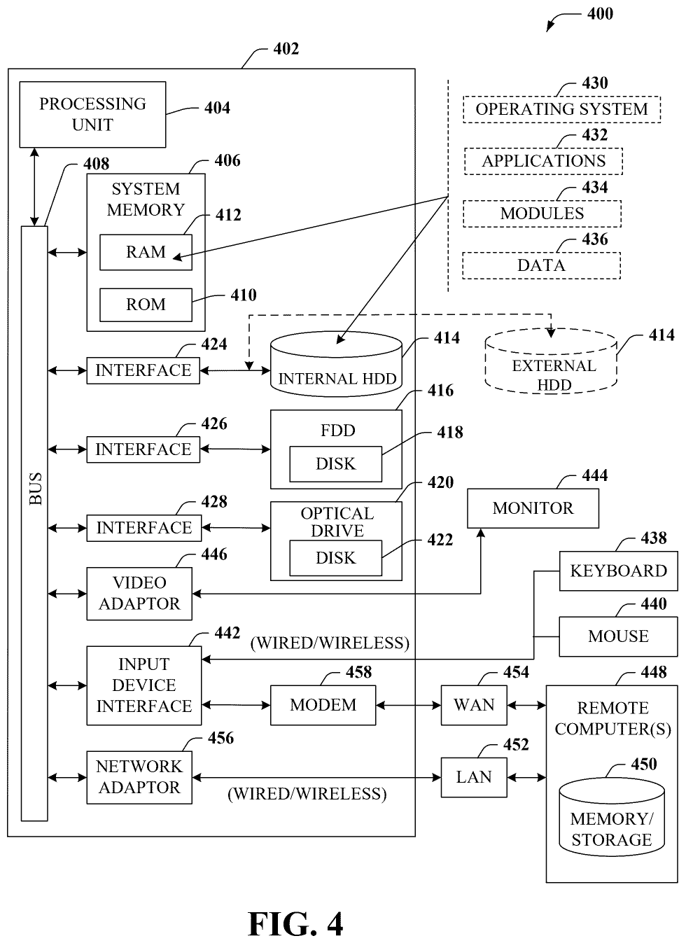

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part pacing of a portfolio as described elsewhere herein.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per sc as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
receiving a set of user inputs,
wherein the set of user inputs includes a target portfolio market value, a target portfolio growth rate, a target strategic asset allocation (SAA) percentage, a desired allocation percentage for one or more asset classes, a desired number of future equal periodic capital commitments, a desired timeframe for achieving the target SAA percentage, or a combination thereof;
obtaining a plurality of projections for the one or more asset classes based on an aggregated dataset relating to the one or more asset classes and based on information regarding existing capital commitments made in the one or more asset classes;
determining a set of values based on the set of user inputs and the plurality of projections,
wherein the set of values includes a proposed amount of each of the future equal periodic capital commitments, a projected timeframe for reaching the target SAA percentage, proposed amounts of varying future capital commitments for individual periods in the desired timeframe, a rate of change relating to the proposed amounts of varying future capital commitments, or a combination thereof; and
deriving and presenting a portfolio plan using the set of values.

2. The device of claim 1, wherein the target SAA percentage comprises a private investment (PI) SAA percentage of a total portfolio.

3. The device of claim 1, wherein the one or more asset classes comprise private investment (PI) asset classes that include private credit, core private equity (PE), growth equity or venture capital, and real assets.

4. The device of claim 1, wherein the set of values further comprises proposed amounts of additional future capital commitments that are needed to maintain the target SAA percentage.

5. The device of claim 1, wherein the plurality of projections comprise a projected net asset value (NAV)-to-committed-capital conversion ratio for at least one of the one or more asset classes.

6. The device of claim 1, wherein the plurality of projections comprise a projected net asset value (NAV) of existing capital commitments for at least one of the one or more asset classes.

7. The device of claim 1, wherein, for a portfolio plan that involves equal periodic capital commitments, the set of user inputs includes the target portfolio market value, the target portfolio growth rate, the target SAA percentage, the desired allocation percentage for the one or more asset classes, and the desired number of future equal periodic capital commitments, and the set of outputs includes the proposed amount of each of the future equal periodic capital commitments and the projected timeframe for reaching the target SAA percentage.

8. The device of claim 1, wherein, for a portfolio plan that involves decreasing periodic capital commitments, the set of user inputs includes the target portfolio market value, the target portfolio growth rate, the target SAA percentage, the desired allocation percentage for the one or more asset classes, and the desired timeframe for achieving the target SAA percentage, and the set of outputs includes the proposed amounts of varying future capital commitments for individual periods in the desired timeframe, a rate of change relating to the proposed amounts of varying future capital commitments, or both.

9. The device of claim 1, wherein the determining involves an analysis of the aggregated dataset.

10. The device of claim 1, wherein the determining is based at least in part on an assumption that additional committed capital made for each period for a given asset class follows a median level residual-value-to-committed capital (RVCC) trajectory.

11. The device of claim 1, wherein the determining involves use of a quantitative model that is configured to generate a range of cash flow projections relating to paid-in capital, distributions, net asset value (NAV), or a combination thereof.

12. The device of claim 1, wherein the determining comprises solving for one or more conditions involving various inputs in the set of user inputs.

13. The device of claim 1, wherein one or more of the receiving, the deriving, and the presenting are performed via a user interface (UI).

14. The device of claim 1, wherein at least a portion of the portfolio plan is presented in one or more graphs, one or more tables, or a combination thereof.

15. A non-transitory machine-readable medium, comprising executable instructions that, when executed by a processing system including a processor, facilitate performance of operations, the operations comprising:
receiving a set of user inputs,
wherein the set of user inputs includes a target portfolio market value, a target portfolio growth rate, a target strategic asset allocation (SAA) percentage, a desired allocation percentage for one or more asset classes, and a desired number of future equal periodic capital commitments;
obtaining a plurality of forecasts for the one or more asset classes based on an aggregated dataset relating to the one or more asset classes and based on information regarding existing capital commitments made in the one or more asset classes;
deriving a set of values based on the set of user inputs and the plurality of forecasts,
wherein the set of values includes a proposed amount of each of the future equal periodic capital commitments and a projected timeframe for reaching the target SAA percentage; and
deriving and presenting a proposed portfolio plan based on the set of values.

16. The non-transitory machine-readable medium of claim 15, wherein the set of values further comprises proposed amounts of additional future capital commitments that are needed to maintain the target SAA percentage.

17. The non-transitory machine-readable medium of claim 15, wherein the one or more asset classes comprise private investment (PI) asset classes that include private credit, core private equity (PE), growth equity or venture capital, and real assets.

18. The non-transitory machine-readable medium of claim 15, wherein the plurality of forecasts comprise a projected net asset value (NAV)-to-committed-capital conversion ratio for at least one of the one or more asset classes and a projected NAV of existing capital commitments for at least one of the one or more asset classes.

19. A method, comprising:
receiving, by a processing system including a processor, a set of user inputs,
wherein the set of user inputs includes a target portfolio market value, a target portfolio growth rate, a target strategic asset allocation (SAA) percentage, a desired allocation percentage for one or more asset classes, and a desired timeframe for achieving the target SAA percentage;
obtaining, by the processing system, a plurality of projections for the one or more asset classes based on an aggregated dataset relating to the one or more asset classes and based on information regarding existing capital commitments made in the one or more asset classes;
determining, by the processing system, a set of values based on the set of user inputs and the plurality of projections,
wherein the set of values includes proposed amounts of varying future capital commitments for individual periods in the desired timeframe and a rate of change relating to the proposed amounts of varying future capital commitments; and
deriving and presenting, by the processing system, a portfolio plan using the set of values.

20. The method of claim 19, wherein the set of values further comprises proposed amounts of additional future capital commitments that are needed to maintain the target SAA percentage.
